(19) United States
(12) Patent Application Publication
(10) Pub. No.: US 2023/0047891 A1
(43) Pub. Date: Feb. 16, 2023

(54) ELECTRICAL AMPLIFICATION SYSTEMS THROUGH RESONANCE

(71) Applicant: Adrew R Alcon, Fort Worth, TX (US)

(72) Inventor: Adrew R Alcon, Fort Worth, TX (US)

(21) Appl. No.: 17/967,366

(22) Filed: Oct. 17, 2022

Related U.S. Application Data
(63) Continuation-in-part of application No. 16/350,749, filed on Dec. 31, 2018.
(60) Provisional application No. 62/709,944, filed on Feb. 6, 2018.

(51) Int. Cl. H02J 7/32; H02K 7/18; H02K 35/02; H02P 9/04

(52) U.S. Cl. CPC H02J 7/32; H02K 7/1876; H02K 35/02; H02P 9/04

(57) ABSTRACT

An apparatus and method to induce and regulate electrical energy through resonance and vibration whereby producing voltage and current generation with increased efficiency within DC electrical motors by a high frequency resonant vibration of the motor armature, including the capability to tune and control the regulation of the output current and voltage by the addition of electrical components.

### CROSS REFERENCE TO RELATED APPLICATIONS

The present application is a continuation-in-part of U.S. patent application Ser. No. 16/350,749, filed Dec. 31, 2018, currently pending, which claims priority to U.S. Provisional patent application Ser. No. 62/709,944, filed on Feb. 6, 2018, now expired. Each of the applications listed above is hereby expressly incorporated herein by reference in their entirety.

### BACKGROUND OF INVENTION

### 1. Field of the Invention

A device, method, and process that produces electric current and voltage by the vibration of the electrical motors, including the capability to tune and control the output current and voltage by the addition of electrical components with predictable results.

### 2. Description of Prior Art

It is stated that it is scientifically impossible to create a “perpetual motion machine” due to factors such as friction, gravity, and so forth. It is also understood that a fine line may exist between a “perpetual motion machine” and a “highly efficient machine”.

The current industry is constantly looking for effective, durable, and cost-effective methods of providing power. Thus, there is a need for a new and improved device, apparatus, system, and method of use for power creation. The current invention provides a result where the prior art fails.

### SUMMARY OF THE INVENTION

In view of the disadvantages inherent in the known types of power creation now present in the prior art, the present invention provides an efficient device desired by the current needs. As such, the general purpose of the present invention, which will be described subsequently in greater detail, is to provide a new and improved device, system, and method for power generation, which has all the advantages of the prior art and none of the disadvantages.

It has been discovered that permanent magnet DC motors, especially those having ferromagnetic elements, can utilize input of resonant vibrational power to produce electrical energy to operate the motor.

The vibrational energy acts upon the motor to provide an electrical and mechanical output. Additionally, the resonant power to the motor not only provides a mechanical output from the motor, but also generates a supplemental electrical energy output from its motor terminals that can be cycled through the motor and used by an outside electrical load. The vibrational energy delivered to the DC motor is measured as a very high AC voltage with a frequency in the KHz range.

It has also been found that laminated iron cores combined with insulated copper or aluminium conductors can also utilize input of resonant vibrational power to produce electrical energy to power outside electrical loads. The use of diodes (to rectify the AC power to DC power), inductor or transformer coils (an electrical component comprising of a length of wire around ferromagnetic cores), capacitors (an electrical device having two conducting plate surfaces used to store charge on its plates that are separated by a dielectric insulator), and other system components are used to convert, control, and regulate the high frequency AC power produced by the resonant vibrations of the generator/motor into DC power to run the generator/motor and power the external load.

The present device, method, and process discloses the rectification of a high voltage AC output with a frequency in the KHz range on a permanent magnet DC generator/motor through the vibrational energy of the generator/motor itself. The vibrational energy can be delivered to the permanent magnet generator/motor by attaching a transducer or other means of vibrational energy from the circuit board and transformer directly to the generator/motor or to an electrically conductive fixture attached to the generator/motor. The permanent magnet generator/motor can either be resting on the fixture or otherwise attached to a fixture in a manner not foreseen or hereby to discovered prior to the present invention. The conversion potential produces an exceptionally enhanced conversion differential, from other previously unknown means. Electro-vibrational energy is demonstrated and disclosed by using a tuned resonant transducer (or other means of vibrational energy), which is matched with the resonant frequency of the permanent magnet generator/motor armature and conductors contained within the housing. Secondary electrical components can be used to rectify, enhance, control, and regulate the power output of the system verses the vibrational amplitude input with predictable results. If the wrong electrical values are used with certain components, the results will be a decrease in output efficiency of the system or a complete nullification of its function. However, using the same components within an optimal characteristic range will exponentially enhance the efficiency of the previously unknown and unproven electrical generation of the methods and processes.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception upon which this disclosure is based may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These, together with other objects of the invention, along with the various features of novelty, which characterize the invention, are pointed out with particularity in the claims annexed to and forming a part of this disclosure. For a better understanding of the invention, its operating advantages, and the specific objects attained by its uses, reference should be had to the accompanying drawings and descriptive matter in which there are illustrated preferred embodiments of the invention.

The present invention referred to throughout may be embodied in other specific forms without departing from its spirit or essential characteristics. The described embodiments are to be considered in all respects only as illustrative and not restrictive. Furthermore, each of the methods that have been described should also be considered only as illustrative and not restrictive.

### BRIEF DESCRIPTION OF THE PICTORIAL ILLUSTRATIONS, GRAPHS, DRAWINGS, AND APPENDICES

The invention will be better understood and objects other than those set forth above will become apparent when consideration is given to the following detailed description thereof. Such description makes reference to the annexed pictorial illustrations, graphs, drawings, exhibits, and appendices wherein:

FIG. 1 is a schematic drawing of a 100 watt @ 40 KHz driver board for ultrasonic transducers used for a test system.

FIG. 2 is a first embodiment of a circuit diagram involving an electrical amplification system through resonance.

FIG. 2a is an alternative embodiment to FIG. 2 of a circuit diagram involving an electrical amplification system through resonance.

FIG. 3 is a second embodiment of a circuit diagram involving an electrical amplification system through resonance.

FIG. 3a is an alternative embodiment to FIG. 3 of a circuit diagram involving an electrical amplification system through resonance.

FIG. 4 is a third embodiment of a circuit diagram involving an electrical amplification system through resonance.

FIG. 5 is a drawing indicating a DC electrical generator/motor sitting on an upper surface of an elevated vibrational support platform, with a lower surface of the elevated vibrational support platform attaching a transducer which induces a controlled electro-mechanical vibrational force to the elevated vibrational support platform as involved in FIGS. 2-4.

FIG. 6 is a pictorial view of a dual wound/dual commutator armature for a permanent magnet DC generator/motor.

FIG. 7 is a schematic view of the dual wound generator/motor receiving power from the circuit board and battery and returning power back to the battery and circuit board.

FIG. 8 is a view of the transducer pair with their piezo elements arranged with their polarity opposite from one another to produce a push/pull configuration for the present invention.

FIG. 9 shows an attachment of the ultrasonic devices attached to the opposite ends of the generator/motor.

FIG. 10 shows an alternative circuit board design to FIG. 1, which provides direct power to the resonant circuit without the use of ultrasonic transducers.

FIG. 11 shows an alternative resonant circuit without the use of ultrasonic transducers.

FIG. 12 shows an alternative resonant circuit without the use of ultrasonic transducers and without the use of an external stator magnetic field assembly.

### DETAILED DESCRIPTION OF THE PREFERRED EMBODIMENTS

The current invention may be classified as a system, method, apparatus, and/or combinations thereof. The following detailed description does not define any aspect in a particular order of importance but rather attempts to organize the following for convenience only.

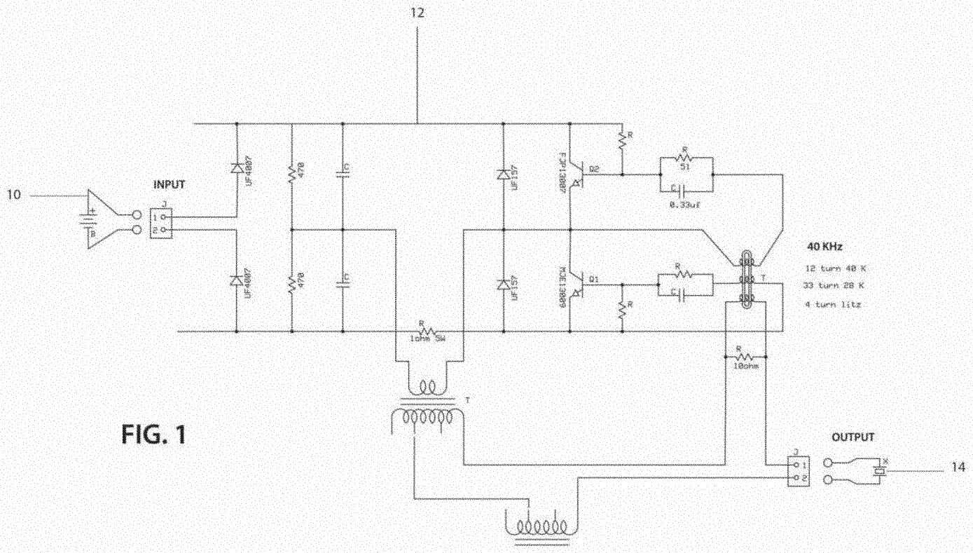

FIG. 1 is a schematic view of a 100 watt @ 40 KHz driver board 12, which was used in a preliminary test. A power source such as a battery 10 is used to power the driver board 12. The driver board 12 is composed of common electrical components such as diodes, resistors, capacitors, transistors, inductors, and transformers as shown in the schematic view. The driver board 12 output is connected to a transducer 14 which delivers electro-mechanical energy to the work piece.

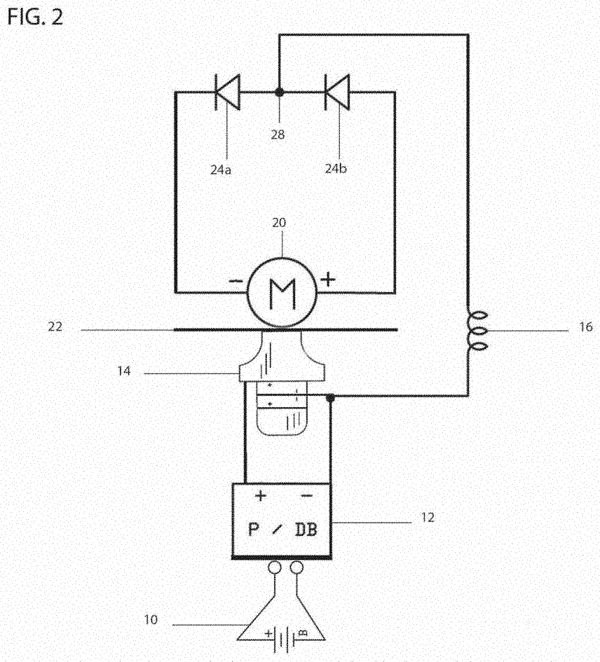

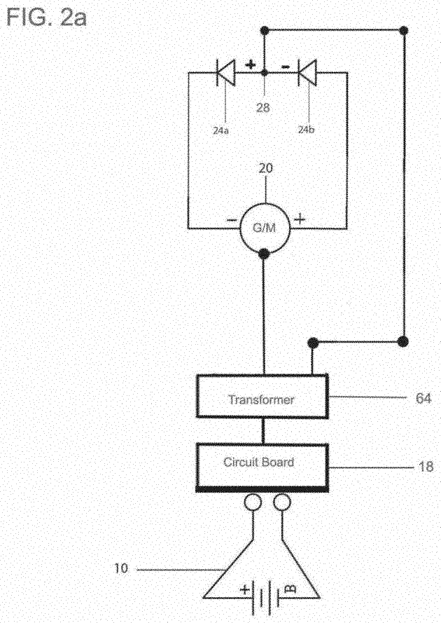

FIG. 2 is a schematic view of our generator/motor driver configuration. A perspective view of the transducer 14 is shown in the drawing. The driver board 12 is shown powered by the battery 10. The driver board 12 symbols+ and − represent the connection points of the driver board 12 to the transducer 14. The horn of the transducer 14 is secured to the underside of an electrically conductive surface 22, defining an electro-acoustical plate conducting electro-mechanical energy directly to a singular generator/motor 20, resting atop the electrically conductive surface 22 as seen in the schematic. The driver board 12 discloses a minus (−) output side that is connected to the junction of the piezo elements of transducer 14. An electrical circuit running from the junction of the piezo elements of transducer 14 travels through a tuned inductor 16 to a junction 28 between two diodes 24a and 24b. The diode 24a is connected to the negative terminal of generator/motor 20 and the diode 24b is connected to the positive terminal of generator/motor 20 forming a closed circuit between the terminals of the generator/motor 20. When the transducer 14 is turned on, the generator/motor 20 rotates itself without a prime mover under this configuration. The direction of the motor rotation is determined by diode direction connecting the positive and negative motor terminals. If the direction of the diode configuration is reversed between the motor positive and negative terminals, the shaft rotation will reverse relative to facing the brush assembly.

FIG. 2a is a schematic view of the ferromagnetic DC generator/motor 20 driver configuration. A circuit board 18 with transformer 64 is shown powered by the battery 10. The transformer 64 terminals directly connect to the conductive surface of the ferromagnetic DC generator/motor 20 and the junction 28 between two diodes 24a and 24b. The diode 24a is connected to the negative terminal of generator/motor 20 and the diode 24b is connected to the positive terminal of generator/motor 20 forming a closed circuit between the terminals of the generator/motor 20. When the circuit board 18 is turned on and tunes the transformer 64 to the resonant frequency of the generator/motor 20, the generator/motor 20 rotates itself without a prime mover under this configuration. The resonant frequency is obtained by viewing the maximum amperage drawn through an amp meter at any given power to the circuit board 18. The direction of the motor rotation is determined by diode direction connecting the motor terminals. If the direction of the diode configuration is reversed between the motor terminals, the shaft rotation will reverse relative to the terminals facing the brush assembly.

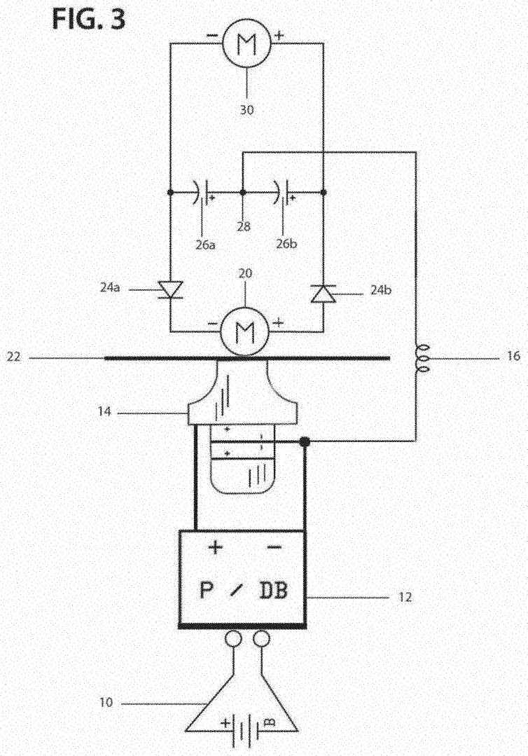

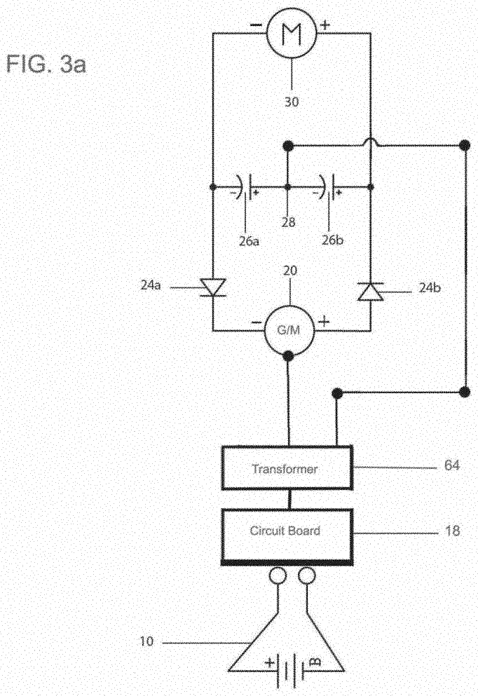

FIG. 3 is a schematic view of a dual generator/motor 20 driver configuration. A perspective view of the transducer 14 is shown in this drawing. The driver board 12 is shown powered by the battery 10. The driver board 12 symbols+ and − represent the connection points of the driver board 12 to the transducer 14. The horn of the transducer 14 is secured to the base of an electrically conductive surface 22, which conducts electro-mechanical energy directly to the generator/motor 20 seen in the schematic. The driver board 12 discloses a minus (−) output side that is connected to the junction of the piezo elements of transducer 14. An electrical circuit running from the junction of the piezo elements of transducer 14 travels through the tuned inductor 16 to series junction 28 between two capacitors 26a and 26b. The negative terminal of capacitor 26a is connected to the diode 24a facing the negative terminal of driver generator/motor 20. The positive terminal of capacitor 26b is connected to the diode 24b facing away from the positive terminal of the generator/motor 20. A positive terminal of motor 30 is connected to the positive terminal of capacitor 26b and a negative terminal of motor 30 is connected to the negative terminal of capacitor 26a. As the transducer 14 sends electro-mechanical energy through the base plate of conductive surface 22 to generator/motor 20, a high voltage AC current is generated and is rectified to pass through diodes 24a and 24b to charge capacitors 26a and 26b. As generator/motor 20 experiences the electrical load of charging capacitors 26a and 26b, it begins to rotate as a motor. As the voltage increases on capacitors 26a and 26b, the motor 30 begins to rotate from the power received from capacitors 26a and 26b. It should be noted that if a mechanical load is placed upon the drive shaft of motor 30, the increased electrical load experienced by generator/motor 20 will cause an increase in the RPM drive shaft velocity of generator/motor 20.

FIG. 3a is a schematic view of the circuit board 18 and transformer 64 that is designed to operate at a variable frequency output from the circuit board 18. The resonant frequency of the output circuit connects between the casing of the generator/motor 20 and the junction 28 between capacitor 26a and capacitor 26b. The capacitors 26a and 26b are wired together in a series and are connected to the electrical terminals of motor 30. When the circuit is energized, and the generator/motor 20 casing is positive and the junction 28 is negative, current flows through diode 24b to charge capacitor 26b. When the circuit reverses polarity and the generator/motor 20 casing is negative and the junction 28 is positive, current flows through diode 24a to charge capacitor 26a. Capacitors 26a and 26b deliver their power to motor 30, which draws their charging current from the generator/motor 20. The power of the generator/motor 20 is determined by the input power of circuit board 18 and the tuned output frequency of the transformer 64 powering the circuit at its resonant frequency. The generator/motor 20 operates exactly the opposite of a conventional DC generator. The greater the electrical current output that it delivers as a generator to a load, the greater the mechanical torque output that it delivers through its shaft as a motor at any given power input from the transformer 64.

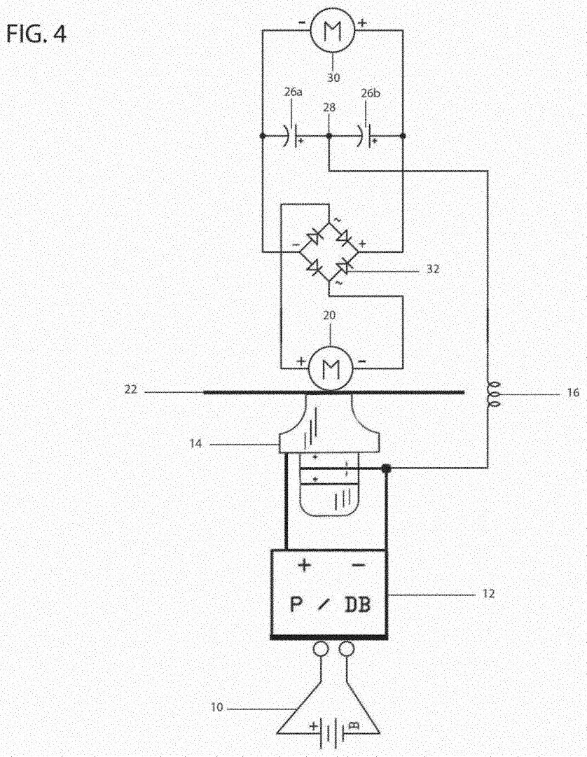

FIG. 4 is a schematic view of dual generator/motor 20 driver configuration, which is similar to the schematic view seen in FIG. 3. A perspective view of the transducer 14 is shown in this drawing. The driver board 12 is shown powered by the battery 10. The driver board 12 symbols+ and − represent the connection points of the driver board 12 to the transducer 14. The horn of the transducer 14 is secured to the base of the electrically conductive surface 22, which conducts electro-mechanical energy directly to the generator/motor 20 seen in the schematic. The driver board 12 discloses a minus (−) output side that is connected to the junction of the piezo elements of transducer 14. An electrical circuit running from the junction of the piezo elements of transducer 14 travels through the tuned inductor 16 to series junction 28 between two capacitors 26a and 26b. The negative terminal of capacitor 26a is connected to the negative side of a full wave bridge rectifier 32, which is connected to receive the high frequency AC output of the generator/motor 20. The positive terminal of capacitor 26b is connected to the positive side of the full wave bridge rectifier 32, which is connected to receive the high frequency AC output of generator/motor 20. A positive terminal of motor 30 is connected to the positive terminal of capacitor 26b and a negative terminal of the motor 30 is connected to the negative terminal of capacitor 26a. As the transducer 14 sends electro-mechanical energy through the base plate of conductive surface 22 to generator/motor 20, a high voltage AC current is generated and is rectified to pass through the full wave bridge rectifier 32 to charge capacitors 26a and 26b. As the voltage increases on capacitors 26a and 26b, the motor 30 begins to rotate from the power received from capacitors 26a and 26b. The use of the full wave rectifier 32 prohibits generator/motor 20 from rotating.

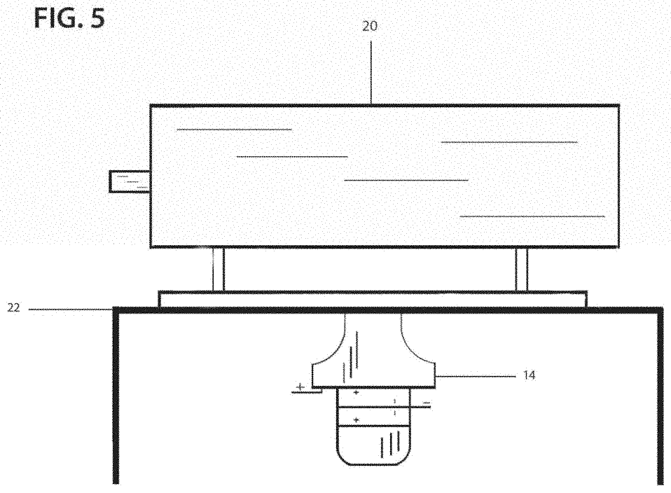

FIG. 5 is a perspective view of generator/motor 20 mounted on top of electrically conductive plate 22. Transducer 14 is bolted to the electrically conductive plate 22 to transfer electromechanical energy to the generator/motor 20 when the transducer 14 is operational.

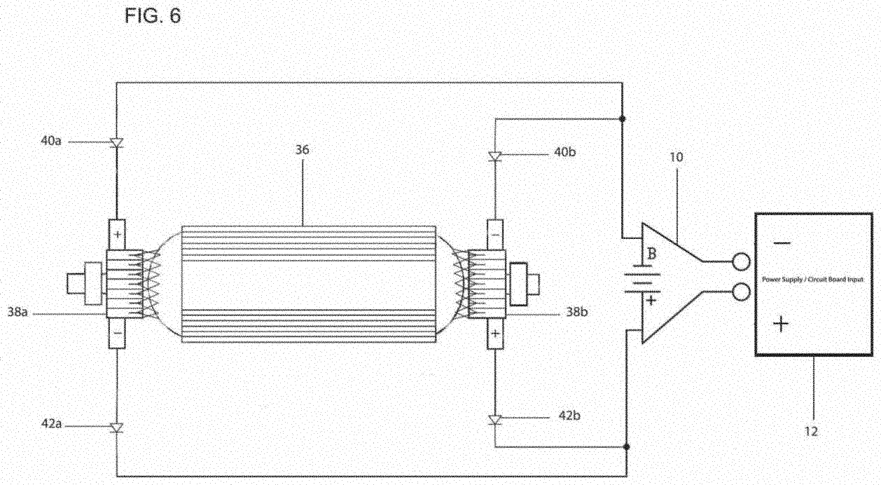

FIG. 6 discloses a dual wound armature 36 with two commutators 38a and 38b. The windings of commutator 38a and 38b are electrically isolated from one another. Commutator 38a is provided with two diodes 40a and 42a. Diode 40a faces toward the positive terminal of commutator 38a and diode 42a faces away from the negative terminal of commutator 38a. Commutator 38b is provided with two diodes 40b and 42b. Diode 40b faces toward the negative terminal of commutator 38b and diode 42b faces away from the positive terminal of commutator 38b. Diode 40a and 40b are connected in parallel to the negative terminal of battery 10. Diodes 42a and 42b are connected in parallel to the positive terminal to battery 10. When generator/motor 20 containing armature 36 receives electro-mechanical energy, the armature will rotate in a counterclockwise rotation when facing commutator 38a and a clockwise rotation when facing commutator 38b. The advantage of using dual commutator armature 36 is that both sides of the resonant wave form will be utilized to produce constant torque on armature 36 while providing more energy to charge battery 10 while it is powering circuit board 18.

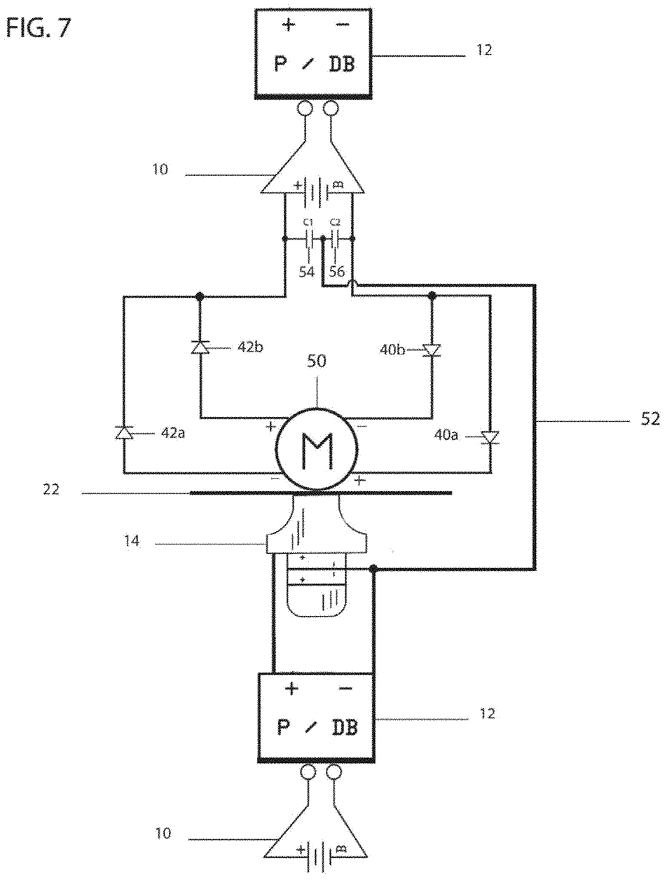

FIG. 7 discloses an external schematic view of the power loop disclosure provided in FIG. 6. Battery 10 provides power to the driver board 12 that sends output voltage to transducer 14, which is secured to the electrically conductive surface 22. Electro-acoustical energy is transferred from the horn of transducer 14 through the electrically conductive surface 22 to a dual wound/dual commutator generator/motor (dw/dc motor) 50, when the transducer 14 is powered and operational. Diodes 40a and 40b are connected to and facing away from the negative terminal of battery 10 and they are connected to the respective commutators and their terminals described in FIG. 6. Diodes 42a and 42b are connected to and facing toward the positive terminal of battery 10 and they are connected to the respective commutators and their terminals described in FIG. 6. An electrical circuit 52 is provided to deliver electro-mechanical resonant energy between the junction of the piezo elements of transducer 14 and junction between two capacitors (C1) 54 and (C2) 54 connected in series. The external terminal of capacitor (C1) 54 is connected to the positive terminal of battery 10 and the external terminal of capacitor (C2) 56 is connected to the negative terminal of battery 10. The electro-mechanical resonant energy, which is transferred from the junction of the piezo elements of transducer 14 to the series junction between the two capacitors (C1) 54 and (C2) 56 transfer the electro-mechanical energy to the armature windings of the dw/dc generator/motor 50. When the dc/dw motor 50 receives electro-acoustical energy from the horn of transducer 14 and electro-mechanical energy from the junction of the piezo elements of transducer 14 to the armature windings, it will charge the battery 10, which provides electrical power to the driver board 12 that powers the transducer 14. The energy loop seen in FIG. 7 discloses that the battery 10 and driver board 12 seen on the bottom of the schematic are the same battery 10 and driver board 12 seen at the top of the schematic. The dw/dc generator/motor 50 will rotate without a prime mover attached to it, while it is charging the battery 10. The overall system efficiency is determined by a number of factors including resonant frequency of transducer 14, signal amplitude and output rating of circuit board 18, and the size and dimensions of length to diameter ratio of the dw/dc motor 50.

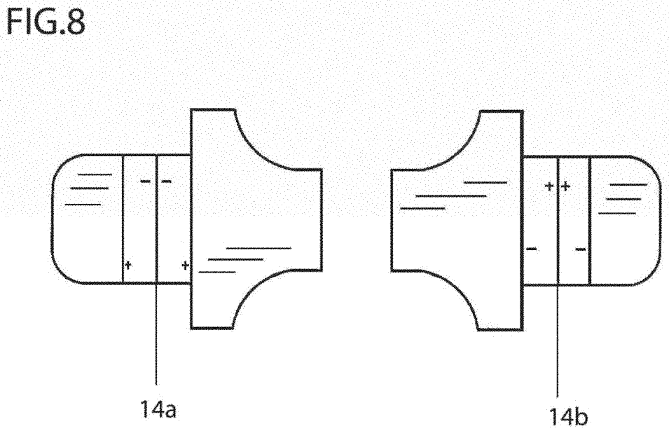

FIG. 8 discloses a pair of transducers 14a and 14b. Transducer 14a has a pair of piezo elements whose negative polarities are facing one another and whose positive polarities are facing outward toward the frontal horn and rear base. Transducer 14b has a pair of piezo elements whose positive polarities are facing one another and whose negative polarities are facing outward toward the frontal horn and rear base. The transducers 14a and 14b are paired up and connected in parallel to one another with an electrically suitable alternating current source to be utilized in a push-pull configuration to form an electro-mechanical circuit.

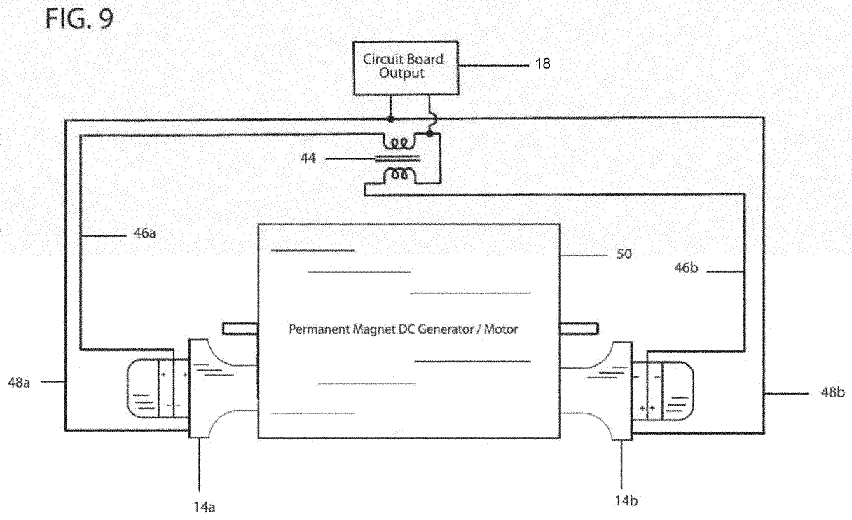

FIG. 9 discloses a detailed schematic and perspective view of the brief disclosure provided in FIG. 8. Transducers 14a and 14b are secured to opposite ends of permanent magnet DC generator/motor 50. The point of contact between transducers 14a and 14b and the dw/dc generator/motor 50 is electrically conductive. Circuit board 18 provides a suitable alternating current source to transducers 14a and 14b, which are connected in a parallel circuit configuration to the alternating electrical outputs of circuit board 18. A circuit 48a connects to the horn of transducer 14a and a circuit 48b connects to the horn of transducer 14b and they share the same electrical output terminal of circuit board 18. A circuit 46a that is connected to the junction of the piezo elements of transducer 14a and the circuit 46b, which is connected to the junction of the piezo elements of transducer 14b share the same electrical output terminal of circuit board 18. A balancing transformer (balun) 44 is connected serially in the electrical circuit to the output terminal of circuit board 18 and the parallel circuits leading to transducers 14a and 14b. Transducers 14a and 14b are configured to operate mechanically 180 degrees out of phase from one another. When transducer 14a is in its longitudinal expansion phase, transducer 14b is in its longitudinal contraction phase and vice versa. The amplification of electro-mechanical resonance along a parallel path of the armature shaft of the generator/motor 50 is obtained when transducers 14a and 14b are operational and their resonant frequency is matched with the resonant frequency of generator/motor 50. As such, the matched resonant frequencies of transducers 14a and 14b with the resonant frequency of the generator/motor 50 provides an extremely efficient electrical power system.

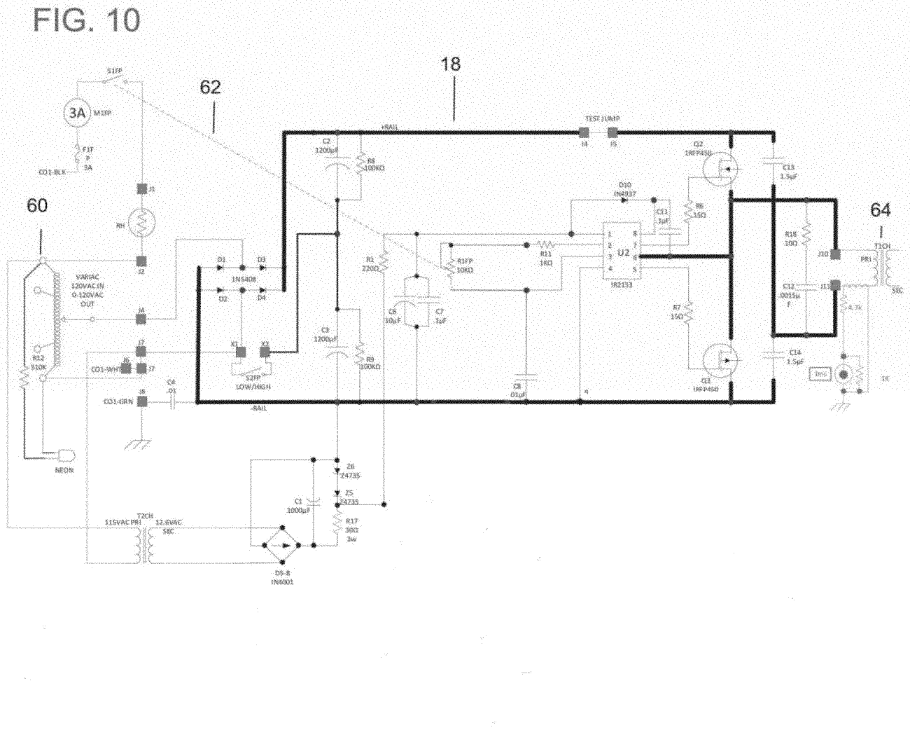

FIG. 10 shows an alternative circuit board 18, which provides direct power to the resonant circuit without the use of ultrasonic transducers. The circuit board 18 is provided with a variable transformer 60 for power control and a variable resistor 62 for frequency control. The output transformer 64 delivers the resonant frequency to the circuit. The circuit board 18 may be powered by a DC to AC power inverter (not seen), which is powered by a battery or capacitor array. The resonant frequency of the circuit receiving the power from the output transformer 64 is found by monitoring the power of the electrical amperage drawn by the variable transformer 60 of the circuit board 18 from the power inverter through the use of a watt meter (not shown). The resonant frequency is tuned in by adjusting the resistance of the variable resistor 62. The resonant frequency of the circuit is obtained when maximum amperage is drawn by the variable transformer 60 of the circuit board 18 from any fixed power setting of the variable transformer 60.

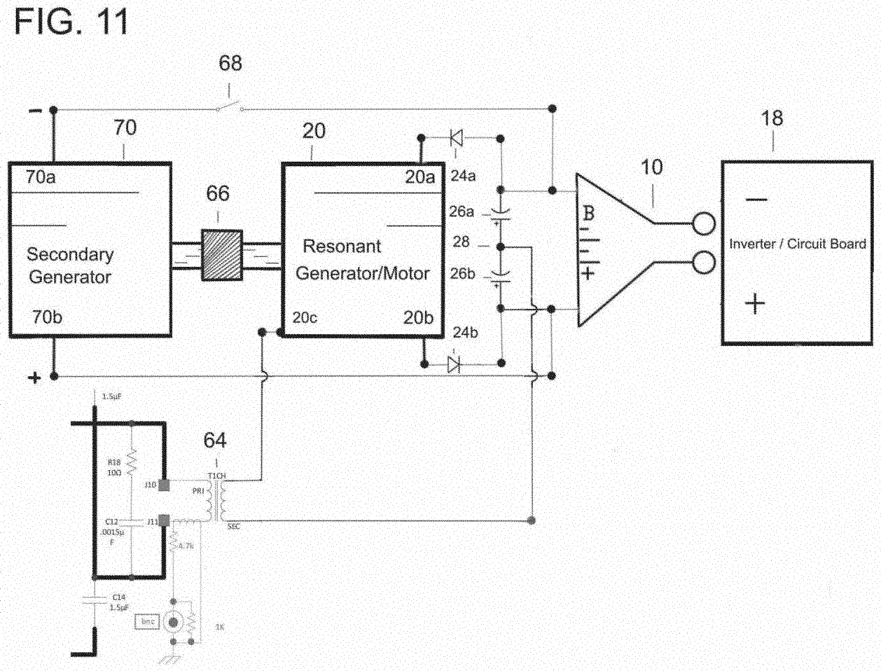

FIG. 11 shows an alternative resonant circuit without the use of ultrasonic transducers. The output transformer 64 is connected to the electrically conductive surface 20c of the resonant generator/motor 20 and the junction 28 between capacitor 26a and capacitor 26b. When the output transformer 64 is energized with a high frequency AC output, the electrically conductive surface 20c of resonant DC generator/motor 20 is electrically polarized and outputs electrical energy to separately charge capacitor 26a and capacitor 26b as the voltage switches polarity within the output transformer 64. When the resonant generator/motor 20 is electrically negative and junction 28 is positive, electrical current will flow from terminal 20a through diode 24a to charge capacitor 26a. When the resonant generator/motor 20 is electrically positive and junction 28 is negative, electrical current will flow from terminal 20b through diode 24b to charge capacitor 26b. Capacitor 26a and capacitor 26b are serially connected together and they transfer their combined voltage through the high frequency charging process to charge battery 10. When electrical current flows from the resonant DC generator/motor 20 to charge the capacitors 26a and 26b that are connected to battery 10, the motor shaft of the resonant generator/motor 20 develops rotational torque, which can be used to rotate a secondary generator 70 that is coupled to the resonant generator/motor 20 through a non-conductive coupling 66 connecting the two motor shafts together. The secondary generator 70 rotates to produce output voltage to power an additional load from its terminals 70a and 70b. If the additional load connected to the secondary generator 70 is battery 10, a switch 68 is included in the circuit to provide the option to open and close the circuit.

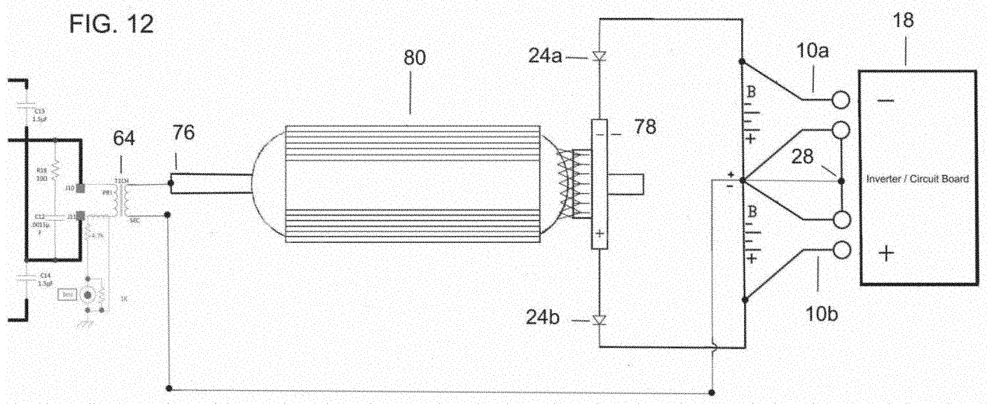

FIG. 12 shows an alternative resonant circuit without the use of an external stator magnetic field assembly. The transformer circuit 64 is secured at one end to an electrically conductive connection 76 of the iron core stack 80, which is insulated from the electrically conductive wire or sheets connected together with an electrically conductive ring or plate 78. The other end of the transformer circuit is connected to the junction 28 of two batteries 10a and 10b, which are connected together in a serial connection supplying power to the inverter/circuit board 18. When the output transformer 64 is energized with a high frequency AC output, to the electrically conductive connection 76 to the iron core stack 80, the iron core stack 80 electrically polarizes the insulated conductors connected to the conductor ring 78. The ring 78 is electrically polarized and outputs electrical energy to separately charge battery 10a and battery 10b as the voltage switches polarity within the output transformer 64. When the iron core stack 80 is electrically negative and junction 28 is positive, electrical current will flow from the conducting ring 78 through diode 24a to charge battery 10a. When the iron core stack 80 is electrically positive and junction 28 is negative, electrical current will flow from conducting ring 78 through diode 24b to charge battery 10b.

### General Devices

Several tested devices were operated using the basic concept of the present apparatus which produces electrical current and voltage by the electro-mechanical vibration of an electrical generator/motor, as indicated in FIGS. 2-5. Three separate demonstrable systems are shown in each of the three circuit diagrams identified in FIGS. 2-4. The initial operative elements comprise an elevated platform defining an upper surface, a lower surface and elevation legs to support the elevated platform above a level operating area, the upper surface upon which is located a ferromagnetic electrical generator/motor identified in FIG. 5.

A transducer is provided, generally by securing it in a suitable manner to the lower surface of the platform, preferably centered below the base of the ferromagnetic electrical DC generator/motor which produces voltage and current. In experiments which provided the proven technology as exposed below, the tested transducer is identified as a 40 KHz @ 100 watt piezoelectric horn powered by a 40 KHZ @ 100 watt circuit board and matching power supply, all commonly indicated in FIGS. 1-4. The transducer is further identified as comprising an upper mass, a lower mass, and two piezo elements electrodes sandwiched between an upper and lower ceramic insulator of the piezoelectric element, with the positive electrode attaching generally to the upper portion of the piezoelectric element directly above the ceramic insulator, with the positive and negative electrodes further attaching to the circuit board operated by a power supply such as a battery or capacitor or other means. The diodes comprising the diode bridge are identified as ultra fast diodes rated at a high voltage.

Symbols within FIGS. 2-4 are derived from commonly known electrical symbols, with the exception being that the power supply and driver board is identified by “P/DB” indicating the power supply and driver board. Most generally the power supply provides an AC current and voltage to the transducer, which compels the transducer to produce a high frequency vibration or resonance within a known and controlled range suitable for the required performance of the operating systems. It is contemplated that other transducers or resonate producing electrical appliances may be used.

The general characteristics of the optimal transducer include being high performance, high mechanical Q-value, high conversion efficiency, large amplitude, with the piezoelectric elements being composed of ceramic materials with a good heat resistance (i.e., 100 watt @ 40 KHz). Stainless steel, bell metal or aluminium is also recommended for the upper and lower mass materials as well as the electrodes. The components noted above generally feature a compression bolt to secure the elements together as a unit, and an insulator is located between the compression bolt, the electrodes and the piezoelectric elements stacked upon one another. An upper surface of the upper mass is most often bonded to the lower surface of the disclosed elevated platform. The upper surface of the elevated platform receives transferred (high voltage) high frequency sound waves through the lower surfaces generated by the transducer. When the transducer commences operation, the resulting high voltage vibrational transferred energy causes the ferromagnetic electrical generator/motor to produce AC voltage which is rectified by the diodes to cause rotation of the generator/motor shaft as disclosed in FIGS. 2-4 and 7. Operation of the ferromagnetic electrical generator/motor is then used to provide mechanical power, electrical current and voltage by a circuit junction from the diode array connected to the generator/motor terminals to the transducer terminal between the piezo discs for supplemental continued operation of the involved system.

The wire including the optional inductor must be connected in a circuit running from one of the diodes connected to a terminal of the generator to the insulated terminal between the piezo discs of the transducer for the system to work. If the incorrect electrical inductor coil is used, either nothing will happen, or the output efficiency will be greatly diminished. The system can operate without the inductor coil as our experimental data shows in the example section of this application. Therefore, some experimentation will be required to match and to either include or exclude the appropriate electrical inductor coil to optimize the power generation and movement of the ferromagnetic generator/motor using the correct and optimal vibrational output of the transducer. This could be done by use of a signal generator connected to the transducer and tuned to the proper electrical frequency with visual or metered monitoring system such as an oscilloscope.

Therefore, the circuit diagrams will indicate this connection as being attached to the insulated terminal of the transducer in FIGS. 2-4. The capacitors used in FIGS. 3-4 are electrolytic capacitors which are rated for high voltage and relatively low micro-farads (400 volts @ 390 uF, et al) although other capacitors with various voltage and storage rating can be used depending upon the application.

In addition, the driver board is used as is illustrated by a schematic example seen in FIG. 1, which has the following essential components: a power cell, which could be a high voltage battery array or capacitor array connected in a series/parallel configuration to supply power to the board, an electrical inductor coil with a transformer, and transistors, which are driven by the toroid transformer to provide a harmonic power supply to generate a resonance within the transducer providing vibrations to the platform and further transferring the specific optimal frequency to the motor casing of the ferromagnetic electrical generator/motor.

### Circuit Board Schematic

FIG. 1 shows a preferred embodiment of a schematic view of the circuit board which is driving our ultrasonic transducers commonly illustrated in FIGS. 1-9 below.

### Single Commutator Generator with Single Transducer

FIG. 2 is identified as an embodiment of an apparatus which produces electrical current and voltage by the vibration of an electrical generator/motor, as identified in the general section above. This device utilizes the single ferromagnetic electric permanent magnet DC generator/motor that produces electric current and voltage through a plurality of diodes, which transfers the current and voltage through the diode bridge in the manner shown. Between the diodes comprising the diode bridge is a wire, which directs voltage back to the center electrode within the transducer to provide a power circuit between the generator/motor windings and the transducer. The ferromagnetic generator/motor of the first embodiment produces the voltage, generated solely by the electro-mechanical vibrational forces of the platform, and also induces the spin of the generator/motor shaft within the ferromagnetic electrical generator/motor, thereby creating a mechanical force as well as a contemporary electrical current at a high voltage and much higher than the input voltage going into the transducer.

### Single Commutator Generator without the Use of a Transducer

FIG. 2a is identified as another embodiment of an apparatus, which produces electrical current and voltage by the vibration of a DC electrical generator/motor. This device utilizes the single ferromagnetic electric DC generator/motor that produces electric current and voltage through a plurality of diodes, which transfers the current and voltage through the diode bridge junction in the manner shown. Between the diodes comprising the diode bridge junction is a wire, which alternates voltage back to the transformer to provide a power circuit between the DC generator/motor windings and the diode bridge junction. The ferromagnetic DC generator/motor of this second embodiment produces the voltage and amperage generated solely by the electrical forces of the transformer and also induces the spin of the DC generator/motor shaft within the ferromagnetic electrical DC generator/motor, thereby creating a mechanical rotation as well as a contemporary electrical output current circulating from the DC generator/motor terminals through the diodes. The stator field of the ferromagnetic DC generator/motor can be provided by a permanent magnet, electromagnet, or superconducting magnet.

### Double Motor/Diodes

FIG. 3 is identified as still another embodiment of an apparatus that produces electrical current and voltage by the electro-mechanical vibration of a permanent magnet DC electrical generator/motor, as identified in the general section above. This device utilizes two or more permanent magnet DC electric generator/motors that produce electric current and voltage through a series of diodes, which transfer the current through the diode bridge in the manner shown. Also used is a pair of electrolytic capacitors located within the center of the diode bridge—one prior to and one subsequent to the intersecting wire connection through a circuit leading back to the electrode of the transducer, once again supplying supplemental electrical voltage to and from the transducer. Once again, the first ferromagnetic generator/motor produces high voltage output, generated solely by the electro-acoustical vibrational forces of the platform and also induces the spin of a motor shaft within the first ferromagnetic electrical generator/motor as it delivers power to an outside electrical load by rectifying the high frequency/high voltage AC power to DC power, thereby creating a mechanical force as well as a contemporary electrical current at a high voltage that is much higher than the output voltage coming from the transducer. The power to the second ferromagnetic motor draws output power from the first ferromagnetic generator/motor causing the rotation of its motor shaft. The operational voltage and power of the second ferromagnetic motor is directly related to the voltage placed upon the capacitors from the resonant voltage produced from the first ferromagnetic generator/motor, which is transferred to the capacitors through the diodes. It is further observed that placing a load on the spinning motor shaft of the second ferromagnetic motor increases the rotational RPM of the first ferromagnetic electrical generator/motor and that limiting the rotation of the shaft of the second ferromagnetic motor, the voltage generated by the first ferromagnetic electric generator/motor appears to be reflected back to itself. Thus far, the power enhancement is unmeasured and appears to have no limit potential when scaled up in size. This second embodiment is useful in operating one or more apparatuses that require a rotary shaft for mechanical power and also is useful in operating an apparatus, which requires a charging voltage electrical output, including fuel cells, hydrogen cells and other appliances. It is contemplated that multiple motors could be operated within the system other than the two as shown.

### Double Motor Circuit without Transducer

FIG. 3a is identified as an embodiment of an apparatus which produces electrical current and voltage by the electrical vibration of a magnetic DC electrical generator/motor. This device utilizes the two or more magnetic DC electric generator/motors that produce electric current and voltage through a series of diodes which transfer the current through the diode bridge in the manner shown. Also used is a pair of electrolytic capacitors located within the center of the diode bridge—one prior to and one subsequent to the intersecting wire connection through a circuit leading back to the transformer connected to the circuit board supplying supplemental electrical voltage to and from the transformer. Once again, the first ferromagnetic generator/motor produces high voltage output, generated solely by the electrical forces and also induces the spin of a motor shaft within the first ferromagnetic electrical generator/motor as it delivers power to an outside electrical load by rectifying the high frequency/high voltage AC power to DC power, thereby creating a mechanical force as well as a contemporary electrical current at a high voltage. The power to the second ferromagnetic motor draws output power from the first ferromagnetic generator/motor through the capacitors in the circuit causing the rotation of its motor shaft. The operational voltage and power of the second ferromagnetic motor is directly related to the voltage placed upon the capacitors from the resonant voltage produced from the first ferromagnetic generator/motor, which is transferred to the capacitors through the diodes. It is further observed that placing a load on the spinning motor shaft of the second ferromagnetic motor increases the rotational RPM of the first ferromagnetic electrical generator/motor and that limiting the rotation of the shaft of the second ferromagnetic motor, the voltage generated by the first ferromagnetic electric generator/motor appears to be reflected back to itself. Thus far, the power enhancement is unmeasured and appears to have no limit potential when scaled up in size. This forth embodiment is useful in operating one or more apparatuses, which require a rotary shaft for mechanical power and also is useful in operating an apparatus that requires a charging voltage electrical output, including fuel cells, hydrogen cells and other appliances. The stator field of the ferromagnetic DC generator/motor can be provided by a permanent magnet, electromagnet, or superconducting magnet.

### Double Motor/Bridge Rectifier

FIG. 4 is identified as yet another embodiment of an apparatus that produces electrical current and voltage by the vibration of an electrical generator/motor, as identified in the general section above. This device utilizes the two or more ferromagnetic electric motors that produce to current and voltage through a full wave bridge rectifier, which transfers the current through the full wave bridge rectifier in the manner shown. Also used is a pair of electrolytic capacitors located within a wire bridge as shown between the two current wires further directed towards the second ferromagnetic electric motor, with dual electrolytic capacitors in the middle of the wire bridge —one electrolytic capacitor prior to and one electrolytic capacitor subsequent to an intersecting wire connection through the circuit leading back to the electrode of the transducer, once again supplying supplemental electrical power from the transducer. The first ferromagnetic generator/motor produces high voltage, generated solely by the electro-acoustical vibrational forces of the platform but does not induce the spin of a motor shaft within the first ferromagnetic electrical motor, only producing electrical current at a high voltage that is much higher than the input voltage going into the transducer. The power to the second ferromagnetic motor further generates output power and possibly the rotation of a motor shaft providing a mechanical rotary force to operate a mechanical device or appliance.

The embodiment in FIG. 4 is a solid-state system using the full wave bridge rectifier across the terminals of the first ferromagnetic electric motor (generator/motor) instead of a string of diodes coming off the positive and negative terminals of the second embodiment. In view of the fact that a generator/motor will rotate in a pre-determined direction depending upon the direction of the presented diode array, if a full wave bridge rectifier is placed across the terminals, it would deliver 100% of the energy to the load, but it would no longer behave as a motor, due to the forces that act upon it causing rotation and it would equalize by tapping into both sides of the wave form. It should be anticipated that a device will be designed with a resonant housing possessing a ferromagnetic field and a wire wound core similar to an armature of an electric motor but modified to produce very efficient high voltage electrical power through the electro-resonant vibration of the housing. This device would deliver high frequency AC voltage through the full wave bridge rectifier to power DC circuits.

### Dual Wound/Dual Commutator Rotor

FIG. 6 generally discloses a dual wound/dual commutator armature for permanent magnet DC generator/motor. The windings for each commutator are electrically isolated from the opposing commutator but they share the same magnetic field orientation through their respective armature windings. The diode configuration for the terminals of the opposing commutators supports the constant power for rotor rotation by being able to utilize the power of the high frequency AC voltage through rectifying both sides of the sine wave with the two commutators and their diode configuration. The diode configuration shown in FIG. 6 discloses the necessary configuration for delivering power to a load to support constant power and rotation of the rotor shaft.

### Dual Commutator Dc Generator/Motor Power Loop to and from the Power Supply and Circuit Board

FIG. 7 generally shows an external schematic view of a dual commutator DC generator/motor. The schematic discloses the power loop circuit in which the dual commutator DC generator/motor receives electro-acoustical energy from the transducer which is driven by the power supply/driver board and how it returns power back to power supply/driver board.

### Two Transducers of Opposite Polarities Used for a Parallel Connection

FIG. 8 generally shows two basically identical piezoelectric transducers assemblies shown in the standard construction form. Each transducer comprises of two piezoelectric discs clamped between a respective front driver and rear driver by a central bolt, not shown. It is noted that the piezoelectric discs of FIG. 8 are orientated with their sides reversed and flipped over with respect to one another. The orientation of each transducer is indicated by the plus and minus signs in FIG. 8. The terminals of the transducers are connected in parallel to a single circuit board and power supply. As a result, when positive voltage is supplied to the positive terminal in transducer 14a and simultaneously to the negative terminal of transducer 14b, the clamped assembly of transducer 14a will expand at the same time that the clamped assembly of transducer 14b will contract. When the voltage polarity is reversed, the reverse condition will take place with the opposing transducers. Therefore, the transducers can be coupled to the opposite ends of the permanent magnet DC generator/motor in order to drive the motor at its resonant state. The vibration of the motor casing and armature will oscillate in phase in the same longitudinal direction while the transducers are vibrating at 180 degrees out of phase from one another. This effect is commonly known as a push-pull configuration. While one transducer is in the expansion mode, the other transducer is in the contraction mode. This transducer setup delivers superior electro-resonant power to the motor casing and the windings by coupling a transducer to each end of the motor casing and armature windings.

FIG. 9 shows an alternative embodiment of the present invention including a pair of ultrasonic transducers that are coupled to the opposite ends of the permanent magnet DC generator/motor.

### Circuit Board Design for Variable Frequency and Power Output

FIG. 10 shows an alternative circuit board design which provides direct power to the resonant circuit without the use of ultrasonic transducers. The circuit board is provided with a variable transformer for power control and a variable resistor for frequency control. The transformer output coil delivers the resonant frequency to the circuit.

### Alternative Resonant Circuit without the Use of Ultrasonic Transducers

FIG. 11 shows an alternative resonant circuit without the use of ultrasonic transducers. The resonant generator/motor outputs electrical energy to charge the capacitors which transfers their additional charge to the battery. When electrical current flows from the resonant generator/motor to charge the capacitors that are connected to the battery, the motor shaft of the resonant generator/motor develops rotational torque, which can be used to rotate a secondary generator that is coupled to the resonant generator/motor through a non-conductive coupling connecting the two motor shafts together.

### Solid State Resonant Power Output to Charge a Battery

FIG. 12 shows an alternative resonant circuit without the use of an external stator magnetic field assembly. The transformer circuit is secured at one end to an electrically conductive connection of the iron core stack which is insulated from the electrically conductive wire or sheets connected to the diodes in the circuit. The other end of the transformer circuit is connected to the junction between the batteries, which are wired in a series configuration.

### Performance and Utility

Early experiments observed by the applicant had been performed on vibrating ferrite core inductors over a number of years leading up to the present invention. The experiments included using DC power sources such as a battery, a DC generator, or a DC power supply. The experiments included using high speed transistors, which were powered through a signal generator to deliver square wave pulses of DC power into numerous inductors of varying values from mill-henrys to micro-henrys. The pulses would produce an AC square wave signal in the inductor when the transistor was turned on and off as it delivered pulsed electrical power to the coil. The resonant frequency of each coil could be determined by measuring the DC voltage from two diodes attached on the wires on either end of the inductor. When the peak voltage was measured from the collapsed field of the inductors on the DC side of the diodes then the system would be in a state of tuned resonance. Each inductor value had a resonant frequency related to its value. The higher the inductor value was, the lower its resonant frequency would be. The lower the inductor value was, the higher its resonant frequency would be. It was observed that very high DC voltages could be obtained through the use of diodes on the inductors from the input of pulsed low DC voltages at the resonant frequency of the inductor coil. Other observations showed that the addition of a capacitor to collect the voltage from the diode would significantly increase the measured voltage even further. The capacitor would charge to a higher voltage than the output voltage measured at the diodes. It is believed that the resonant DC voltage from the diodes aided the capacitors to charge to a higher DC voltage than the measured voltage from the diodes. Multiple experiments were performed to collect data. In one experiment, a 1.5-volt AA battery was used as a power source and a high-speed transistor was placed in the circuit to turn on and off at a predetermined frequency which provided a pulsed voltage and current to the ferrite inductor coil. As the frequency was tuned to the resonance of the coil, the measured voltage on the DC side of the diode would increase and peak at the resonance of the coil. The tuned voltage measured above 250 volts on the DC side of the diodes from 1.5 volts of input power into the inductor coil. When a 0.015 mfd capacitor was attached to the DC side of the diode, the voltage measured in excess of 500 volts from the resonant coil. Another experiment was performed in which a DC power supply was used as a power source to send pulses through a transistor into a 30 mH inductor at a predetermined frequency and voltage. A diode was connected to the inductor to charge a 390 mfd-400-volt electrolytic capacitor that was connected to run a 180-volt DC generator/motor. Performance values were taken comparing other inductor core materials to iron such as high frequency ferrite materials. It is also anticipated that other enhanced materials which possesses high mechanical resonance properties may be added in future embodiments of the present invention without departing from the spirit and scope of the present invention.

### Test and Examples

The utility of this device which produces electrical current and voltage by the vibration of an electrical motor is as follows. First, there is the ability to generate electrical energy from an electrical generator/motor without direct electrical input or any mechanical force rotating the motor shaft, other than through vibration of the motor on a platform or other means of providing resonant vibrations to the motor. Second, there is the ability to generate mechanical forces plus the electrical energy, wherein the electrical energy output is actually transferred when a mechanical load is placed on the motor. Third, there is the ability to include mostly passive electrical components to regulate a predictable quantity of electrical energy and mechanical energy output, with enough energy returned to the system to reduce the amount of energy required to continually operate the system to near minimum. Fourth, there is the ability to create a useful power source to operate multiple apparatuses which require extremely high voltage at low current with a minimum amount of input energy. Other useful benefits can be achieved using the basic physical and mechanical implications found within the scope of this disclosed operational system and relevant subject matter, which are previously unknown and had not been discovered until such time as the disclosure of the present invention.

Other examples of this unique form of vibrational energy are disclosed in the following chart showing the tests of four similar but different DC motors. Three of the tested motors were 1.5 HP, DC motors but with different rated voltages from one another. Their rated voltages were 90 volts, 180 volts, and 450 volts. The motors had identical armatures, stator housings and outside dimensions as they came from the same manufacturer. The fourth motor was a 180-volt DC motor; however, its rated horsepower was only 0.33 HP.

Two sets of tests were performed. Each test had two parts to the test. Part 1 of each test used an inductor in the circuit and Part 2 removed the inductor from the circuit. An AC watt meter was used to measure power drawn from the AC power source.

The first test measured the output voltage from each tested motor to a 5 KV electrostatic voltmeter with a 6,000 volt @ 0.015 Mf capacitor connected to its terminals. A string of high voltage diodes was connected to and from the positive and negative terminals of the motor to the voltmeter with a wire running from negative terminal of the voltmeter back to the terminal of the transducer located between the piezo discs of the transducer horn.

The second tests ran a string of diodes connecting the positive and negative terminals of our motor as seen in the schematic diagram of FIG. 2. The tests were made with the inductor shown in the diagram as well as the inductor removed from the circuit. The results of the tests are shown in Table 1 below:

TABLE 1
Test Examples

| Test | Inductor | Motor Size | | Motor Size | | Motor Size | | Motor Size | |
|---|---|---|---|---|---|---|---|---|---|
| 40 KHz | | 90 Volt | | 180 Volt | | 450 Volt | | 180 Volt | |
| Transducer | | 1.5 HP | | 1.5 HP | | 1.5 HP | | .33 HP | |
| Measured | | | | | | | | | |
| Electrostatic | | | | | | | | | |
| Meter Voltage | | | | | | | | | |
| Power Drawn | Yes | 49.4 | Watts | 48 | Watts | 49.3 | Watts | 49 | Watts |
| | No | 48.8 | Watts | 48.3 | Watts | 49.2 | Watts | 51 | Watts |
| Voltage Measured | Yes | 4650 | Volts | 4300 | Volts | 4500 | Volts | 4400 | Volts |
| | No | 4250 | Volts | 4150 | Volts | 4100 | Volts | 3950 | Volts |
| Running voltage | Measured at | | | | | | | | |
| | Motor | | | | | | | | |
| | terminals | | | | | | | | |

| | | | | | | | | |
|---|---|---|---|---|---|---|---|---|
| Power Drawn | Yes | Does Not Run | 33 | Watts | 33 | Watts | 47 | Watts |
| | No | Does Not Run | 50 | Watts | 49.9 | Watts | 48 | Watts |
| Running Voltage | Yes | Does Not Run | 81 | Volts | 87 | Volts | 75 | Volts |
| | No | Does Not Run | 93 | Volts | 105 | Volts | 53.5 | Volts |

The preceding Table 1 shows that the measured resonant voltages between the various motor sizes and their voltage ratings were relatively the same. The 0.33 HP motor rated at 180 volts had a higher voltage reading with the inductor than the 1.5 HP motor rated at 180 volts. The test has caused us to believe that the voltage increases with the amplitude of the signal from the transducer while the amperage increases with the increased mass and size of the ferrite armature which is in the electro-resonant circuit of the transducer.

Although the various embodiments of the invention have been described and shown above, it will be appreciated by those skilled in the art that numerous modifications may be made therein without departing from the scope of the invention as herein described. Changes may be made in the combinations, operations, and arrangements of the various parts and elements described herein without departing from the spirit and scope of the invention.

I claim:

1. An apparatus for production of electrical current, voltage, and mechanical power by a tuned and selected vibration, said apparatus comprising:
a battery defining a positive terminal and a negative terminal, attached to an inverter and a circuit board providing power to conduct electro-mechanical energy through a transformer;
a DC generator/motor, electrically connected with an electrically conductive surface to said transformer powered by said circuit board causing said DC generator/motor to operate by said electro-mechanical energy of said transformer, converting said electro-mechanical energy from said circuit board into operation of said DC generator/motor, producing said electrical current and said voltage to a first terminal and a second terminals of said DC generator/motor upon commencement of operation of said circuit board;
a diode connected to said first terminal of said DC generator/motor and facing toward said first terminal of said DC generator/motor and connected to a negative terminal of a first capacitor;
a diode 24b connected to a second terminal of said DC generator/motor and facing away said second terminal of said DC generator/motor and connected to positive terminal of a second capacitor, with said first capacitor and said second capacitor attached to one another at a common junction;
wherein said negative terminal of said battery is connected to said negative terminal of said first capacitor, and said positive terminal of said battery is connected to said positive terminal of said second capacitor;
a circuit wiring between said junction of said first capacitor and second capacitor and said transformer of said circuit board; and
wherein said electro-mechanical energy generates said current and said voltage from said DC generator/motor through said diodes connected to said first and second terminals of said DC generator/motor, causing said DC generator/motor to rotate an armature shaft and returning said current and said voltage to said first and second capacitors connected to said battery.

2. The apparatus of claim 1 wherein said circuit board is provided with a variable transformer for power control, a variable resistor for frequency control and an output transformer to provide output power to the resonant circuit.

3. The apparatus of claim 1 wherein said first resonant generator/motor is a ferromagnetic permanent magnet DC generator/motor.

4. The apparatus of claim 1 wherein said first resonant generator/motor is a ferromagnetic electro-magnet DC generator/motor.

5. The apparatus of claim 1 wherein said first resonant generator/motor is a ferromagnetic superconducting magnet DC generator/motor.

6. The apparatus of claim 1 further comprising:
a non-electrically conductive coupling connecting the shaft of a secondary generator to the shaft of the resonant generator/motor producing additional electrical current and voltage as the resonant generator/motor rotates the shaft of the secondary generator; and
terminals of the secondary generator are provided with a switch to regulate the power flowing from the secondary generator to the positive and negative terminals of said battery.

7. An apparatus comprising:
a transformer circuit having a first end and a second end secured at said first end to an electrically conductive connection of an iron core stack which is insulated from the electrically conductive wire or sheets connected together with an electrically conductive ring or plate;
said transformer circuit second end is connected to a junction of two batteries which are connected together in a serial connection supplying power to an inverter/circuit board;
wherein when an output transformer is energized with a higher frequency AC output to the electrically conductive connection to said iron core stack, said iron core stack electrically polarizes insulated conductors connected to a conductor ring;
wherein said ring is electrically polarized and outputs electrical energy to separately charge batteries as the voltage switches polarity within said output transformer 64; and
wherein when said iron core stack is electrically negative and said junction is electrically positive, electrical current will flow from said conducting ring through a diode to charge said battery; and
wherein when said iron core stack is electrically positive and said junction is electrically negative, electrical current will flow from said conducting ring through a diode to charge said battery.

8. The apparatus of claim 5 wherein said circuit board is provided with a variable transformer for power control, a variable resistor for frequency control and an output transformer to provide output power to the resonant circuit.
